(19) United States
(12) Patent Application Publication
(10) Pub. No.: US 2009/0015545 A1
(43) Pub. Date: Jan. 15, 2009

(54) Imaging apparatus and operation method of the same

(75) Inventors: Midori Kato, Asaka (JP); Masayoshi Ishibashi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/213,909

(22) Filed: Jun. 26, 2008

(30) Foreign Application Priority Data
Jul. 11, 2007 (JP) 2007-182270

(51) Int. Cl. G09G 3/34

(52) U.S. Cl. 345/107

(57) ABSTRACT

To provide a low-voltage-driven, low-power-consumption, electrophoretic imaging device and an operation method of the same. An electrophoretic imaging device includes an electrode in contact with an electrophoretic dispersion liquid in which particles are dispersed, and a holding electrode disposed on a side of the electrode opposed on a side thereof in contact with the electrophoretic dispersion liquid with an insulating layer interposed between the electrode and holding electrode.

### CLAIM PRIORITY

The present application claims priority from Japanese patent application JP 2007-182270 filed on Jul. 11, 2007, the content of which is hereby incorporated by reference into this application.

### BACKGROUND OF THE INVENTION

1. Field of the Invention

The present invention relates to an imaging apparatus and an operation method of the same. In particular, the invention relates to an electrophoretic imaging device and an operation method of the same.

2. Description of the Related Art

Contemporary society has been called “information society” and a number of information-related devices have come to exist in our life familiarly. As interfaces between such information devices and humans, devices (displays) for displaying characters or images have increased in importance. It is expected that information will be more often converted into electronic form and viewed as necessary on a display of a portable terminal such as a notebook personal computer (PC), a personal digital assistant (PDA), or a cell phone, whether indoor or outdoor, instead of being printed on paper. Under the circumstances, battery-driven, low-power-consumption, portable imaging devices have been demanded.

Reflection imaging devices require no illuminant such as a backlight, so they consume less power. Among such imaging devices, electrophoretic imaging devices that utilize electrophoresis of particles have attracted attention as low-power-consumption imaging devices having good visibility and wide viewing angles.

An electrophoretic imaging device includes an electrophoretic dispersion liquid that is sealed in a transparent cell and in which charged particles are dispersed in a solution, and a collecting electrode and a counter electrode that are both provided in the same cell. By applying a voltage between the electrodes in the cell, the charged particles dispersed in the electrophoretic dispersion liquid migrate toward the collecting electrode. This changes the density distribution of the charged particles in the electrophoretic dispersion liquid, thereby changing the reflectance of the cell. This phenomenon is used as a pixel. An electrophoretic imaging device using this phenomenon is shown in, for example, Japanese Unexamined Patent Application Publication No. 2004-163703.

### SUMMARY OF THE INVENTION

In such an electrophoretic imaging device, a high electric field is generated between a collecting electrode and a counter electrode that are covered by insulators by applying a voltage between the electrodes, and the charged particles migrate due to the high electric field. In order to generate such an electric field, a high voltage of several tens of volts to several hundred volts is generally required. While this voltage is lowered by reducing the distance between the electrodes, doing so means that the amount of the charged particles present between the electrodes is reduced. This prevents sufficient contrast from being obtained.

On the other hand, even in a similar configuration, if the electrodes are in contact with the electrophoretic dispersion liquid without being covered by insulators or the like and if the liquid contains ions, application of a voltage between the electrodes not only generates an electric field but also causes an electrode reaction on the interface between the electrodes. In this case, uneven ion concentrations in the liquid cause a distribution of electric charge, thereby diffusing the ions and charged particles. This diffusion causes migration of the ions and charged particles. In general, an electrode reaction is caused by a sufficiently lower voltage, e.g., on the order of several volts, than a voltage necessary to cause particles to migrate by electrophoresis. Therefore, the migration of the ions and charged particles due to their diffusion is caused by a low voltage of the order of several volts.

However, in such a configuration, an electrode reaction must be continuously caused in order to hold the image. This means that a current is constantly passed, thereby failing to meet the low power consumption requirement.

An advantage of the present invention is to provide an electrophoretic imaging device that is driven by a low voltage as well as requires almost no power for holding an image, and an operation method of the electrophoretic imaging device.

According to an aspect of the present invention, an electrophoretic imaging device is provided with a collecting electrode that is directly in contact with an electrophoretic dispersion liquid in which particles are dispersed, and a holding electrode that is not directly in contact with the electrophoretic dispersion liquid but intended to hold an image. Application of a low voltage to the collecting electrode causes an electrode reaction so that the particles migrate. Subsequently, application of a voltage to the holding electrode generates an electric field so that the particles stay where they are. At that time, the holding electrode is not in contact with the electrophoretic dispersion liquid; therefore, no electrode reaction occurs. That is, no current is passed so that no power is consumed. Specifically, the electrophoretic imaging device includes two substrates disposed so as to be opposed to each other with a predetermined gap therebetween, an electrophoretic dispersion liquid disposed in the gap between these substrates and including ions, and multiple charged particles dispersed in the electrophoretic dispersion liquid so as to be migratable.

The electrophoretic imaging device also includes a first electrode disposed on a surface of one of the two substrates so as to be in contact with the electrophoretic dispersion liquid and charged particles, a second electrode disposed on a surface of the other substrate so as to be in contact with the electrophoretic dispersion liquid and opposed to the first electrode, and a holding electrode disposed on a side of the second electrode remote from the first electrode with an insulating film interposed between the second electrode and holding electrode so as to be insulated from the electrophoretic dispersion liquid. Also, the electrophoretic imaging device includes a drive circuit. This drive circuit applies a voltage between the first and second electrodes so that the charged particles are collected onto the second electrode and, after a given time has elapsed, opens a circuit between the first and second electrodes and simultaneously applies a voltage for keeping the charged particles collected, between the first electrode and holding electrode.

According to the present invention, application of a low voltage between the first and second electrodes in contact with the electrophoretic dispersion liquid allows migration of the particles. Also, application of a holding voltage between the first electrode, and the holding electrode disposed with the insulator interposed between the second electrode and holding electrode allows holding of an image. This allows holding of the image with low power consumption. That is, a low-voltage-driven, low-power-consumption electrophoretic imaging device is obtained.

### BRIEF DESCRIPTION OF THE DRAWINGS

FIG. 1A is a bird eye's view showing pixels of an electrophoretic imaging device according to a first embodiment of the present invention;

FIG. 1B is a bird eye's view showing another configuration of the pixels of the electrophoretic imaging device according to the first embodiment;

FIG. 2A is a conceptual diagram showing a section of one of the pixels shown in FIG. 1A at a time when the pixel is displaying a black image;

FIG. 2B is a conceptual diagram showing a section of the pixel shown in FIG. 2A at a time when the pixel is displaying a white image;

FIG. 2C is a conceptual diagram showing a section of the pixel shown in FIG. 2B at a time when the pixel is holding the white image;

FIG. 3A is a conceptual diagram showing a section of one of pixels of an electrophoretic imaging device according to a second embodiment of the present invention at a time when the pixel is displaying a black image;

FIG. 3B is a conceptual diagram showing a section of the pixel shown in FIG. 3A at a time when the pixel is displaying a white image;

FIG. 4 is a conceptual diagram showing a section of a pixel having a different configuration, of the electrophoretic imaging device according to the second embodiment at a time when the pixel is displaying a black image;

FIG. 5 is a diagram showing a drive circuit of an electrophoretic imaging device according to a third embodiment of the present invention; and

FIG. 6 is a timing chart diagram showing a drive method of the imaging device shown in FIG. 5.

### DETAILED DESCRIPTION OF THE PREFERRED EMBODIMENTS

Now, embodiments of the present invention will be described with reference to the accompanying drawings.

### First Embodiment

Pixels of an electrophoretic device according to a first embodiment of the present invention will be described.

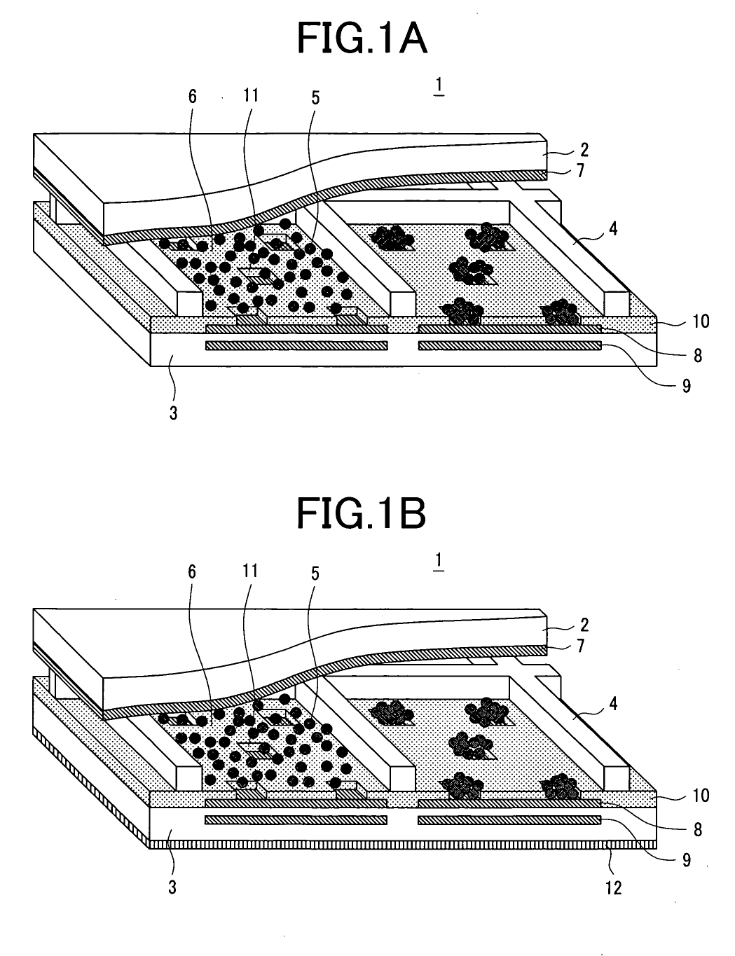

FIGS. 1A and 1B are bird eye's views showing configurations of pixels of the imaging device according to this embodiment. A part of the bird eye's view is cut off in order to show the internal structure of the pixels. Pixels 1 include a first electrode substrate 2 and a second electrode substrate 3 that are disposed at an arbitrary interval, a partition wall 4 disposed between the substrates 2 and 3 and intended to maintain the gap therebetween at a fixed size, and a transparent electrophoretic dispersion liquid 6 with which the space enclosed by the substrates 2 and 3 and the partition wall 4 is filled and in which black, charged particles 5 are dispersed. A first electrode 7 is disposed on a surface of the first electrode substrate 2 so as to make contact with the electrophoretic dispersion liquid 6, while a second electrode 8 is disposed on a surface of the second electrode substrate 3 so as to be opposed to the first electrode 7 with the electrophoretic dispersion liquid 6 therebetween. A holding electrode 9 is disposed in a position away from the second electrode 8 by a given distance inside the substrate 3. The holding electrode 9 and second electrode are electrically insulated from each other. The surface of the second electrode 8 is covered by an insulating film 10 that displays white due to its high reflectance in a visible light area and also serves as a reflection film. The insulating film 10 has multiple openings 11. The sum of the areas of the multiple openings 11 is smaller than one-fourth the area of one of the pixels 1 enclosed by the partition wall 4. The first electrode substrate 2 and first electrode 7 are both made of a transparent material. While a material having a high reflectance is formed as the insulating film 10 in this embodiment, a reflection film 12 may be independently disposed on a surface of the second electrode substrate opposed to the surface thereof in contact with the electrophoretic dispersion liquid 6. In this case, the insulating film 10, second electrode substrate 3, second electrode 8, and holding electrode 9 as well as the first electrode substrate 2 and first electrode 7 must be all made of a transparent material.

In FIG. 1A, two pixels, one displaying a black image and the other displaying a while image, are shown side-by-side. As for the pixel displaying a black image disposed on the left-hand side of FIG. 1A, the black particles 5 are dispersed in the electrophoretic dispersion liquid 6 contained in the pixel. As a result, the pixel as a whole is recognized as a black image. As for the pixel having a white image disposed on the right-hand side of FIG. 1A, the black particles 5 are collected at the openings 11 on the second electrode 8. This lightens the color of the electrophoretic dispersion liquid 6 so that the insulating film serving also as a reflection film is seen through the liquid. As a result, the pixel as a whole is recognized as almost a white image.

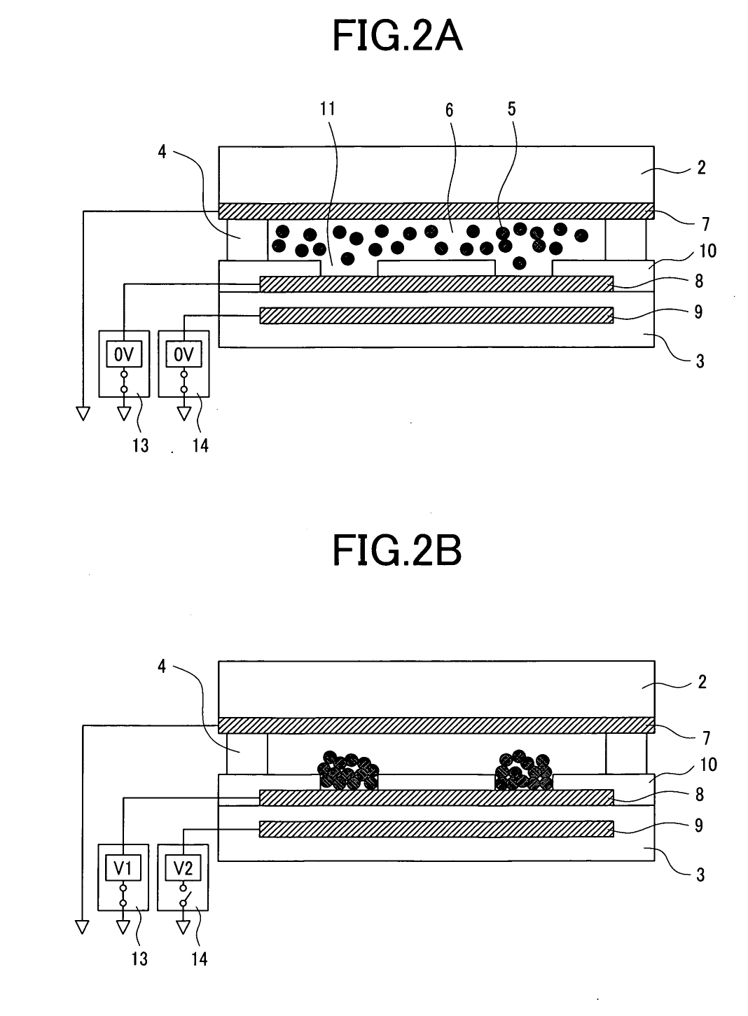

FIGS. 2A and 2B are schematic sectional views of the pixels shown in FIG. 1A. Referring now to FIGS. 2A and 2B, imaging operations of the pixels 1 and an image holding method will be described. FIGS. 2A and 2B show control units as well as the pixels shown in FIG. 1A. Specifically, the first electrode 7 and second electrode 8 are coupled to a ground and a control unit 13 for electrophoresis, respectively. The holding electrode 9 is coupled to a control unit 14 for holding image.

In FIG. 2A, the control unit 13 for electrophoresis and control unit 14 for holding image are both switched on and voltages of zero volts are applied to these units, respectively, as signal voltages. Therefore, the potentials of all the electrodes are equal to one another and the particles 5 are almost uniformly dispersed in the electrophoretic dispersion liquid 6. When seen from a side of the first electrode substrate 2, the pixel displays black that is the color of the electrophoretic dispersion liquid in which the black particles are dispersed.

FIG. 2B shows a state in which, from the state of FIG. 2A, the control unit 14 for holding image is switched off with the control unit 13 for electrophoresis switched on, the power supply voltage of the control unit 13 for electrophoresis is set to V1 volts, and a voltage is applied between the first electrode 7 and second electrode 8 so that the pixel displays white. If the value of the V1 is made a negative value with the particles 5 positively charged, an electrode reaction of ions causes a distribution of electric charge. This causes diffusion of the particles 5 so that the particles 5 are passed through the openings 11 made in the insulating film 10 and then collected on a surface of the second electrode 8 in the openings 11. For this reason, when seen from a side of the first electrode, portions other than the openings 11, of the insulting film 10 serving also as a reflection film are seen through the electrophoretic dispersion liquid. Since the pixel has areas where the white insulating film 10 is seen through the liquid and areas where the black openings 11 are seen, the pixel as a whole looks grey. The color of the pixel comes closer to white as the areas of the openings 11 are reduced.

FIG. 2C shows a state in which after the white image shown in FIG. 2B is completed, the control unit 13 for electrophoresis is switched off and at the same time the control unit 14 for holding image is switched on so that the power supply voltage of the control unit 14 for holding image is set to V2 volts and thus a voltage is applied between the first electrode 7 and holding electrode 9 so that the while image is held. Instead of such steps, a method for applying a voltage for holding an image including the following steps may be used: after the white image is completed, the power supply voltage of the control unit 14 for holding image is set to the V1 volts identical to that of the control unit 13 for electrophoresis; then the control unit 14 for holding image is switched on; the control unit 13 for electrophoresis is switched off; and then the power supply voltage of the control unit 14 for holding image is set to the V2 volts. The voltage V2 applied to the holding electrode 9 has a polarity identical to that of the voltage V1 applied to the second electrode 8. The absolute value of the voltage V2 is larger than that of the V1. Thus, an electric field is generated between the first electrode 7 and holding electrode 9. As a result, a force toward the holding electrode 9 is exerted on the particles 5.

That is, the particles 5 stay in the openings 11. The magnitude of the image holding voltage V2 at that time depends on the distance between the first electrode 7 and holding electrode 9 or the dielectric constant of the electrophoretic dispersion liquid or insulator interposed therebetween. However, it is sufficient that an electric field is generated such that the particles are forced to stay. Therefore, it is sufficient to apply a voltage smaller than a voltage necessary for electrophoresis, in which particles must be moved at a certain level of speed by a force received from an electric field. Since the first electrode 7 and holding electrode 9 are insulated from each other, no electrode reaction occurs at that time. A current to be passed by applying a voltage is only a current that is passed immediately after the voltage is applied and intended to charge a parallel-plate capacitor made up of the first electrode 7 and holding electrode 9. Therefore, no current is passed to hold the white image subsequently and thus no power is consumed. Since the first electrode 7 and holding electrode 9, which are insulated from each other, act as a capacitor, the potential difference therebetween is maintained even if the control unit 14 for holding image is switched off. Accordingly, the white image is maintained.

Subsequently, in order to return to the black image, the power supply voltages of the control unit 14 for holding image and control unit 13 for electrophoresis are both set to zero volts so that both the units are switched on. Thus, the potentials of all the electrodes are equal to one another so that the particles 5 are diffused. As a result, the black image shown in FIG. 2A appears again. Further, by switching off the control unit 14 for holding image in addition to this operation, then setting the power supply voltage of the control unit 13 for electrophoresis to a voltage having a sign reverse to that of the V1, and switching on the control unit 13 for electrophoresis for a short time so as to apply a pulse-like reverse voltage, the particles 5 in the openings 11 may be excluded forcefully so that the speed at which the black image appears again is increased.

When a black image is displayed as shown in FIG. 2A, all the electrodes have identical potentials. Therefore, no power is required to hold the black image. As such, no power is required to hold the while image shown in FIG. 2C, since no current is passed after a normal state is reached. As a result, a low-power-consumption, reflection imaging element is obtained.

While the color of the particles 5 is set to black and that of the insulating film 10 is set to white in this embodiment, the colors of these components may be set to arbitrary colors. Also, the reflection film may be embedded in the second electrode rather than disposed on the back of the second electrode substrate 3. If the reflection film 12 is positioned between the second electrode 8 and holding electrode 9, the holding electrode 9 need not be transparent.

Now, a method for manufacturing the pixels shown in FIG. 1A will be described.

First, a polyethylene terephthalate (PET) film as the first electrode substrate 2 is formed with a thickness of 125 microns and then an indium tin oxide (ITO) film as the first electrode is formed with a thickness of approximately 120 nanometers on a surface of the first electrode substrate 2 by sputtering. Then, a photosensitive resin is applied with a thickness of approximately 6 microns onto the first electrode and then subjected to exposure and development using a mask having a lattice pattern so that the lattice-shaped partition wall 4 is formed.

As such, a PET film substrate as the second electrode substrate 3 is formed with a thickness of 125 microns. Then, an ITO film is formed with a thickness of approximately 120 nanometers on a surface of the second electrode substrate 3 by sputtering and then patterned in the size of a pixel by photolithography so as to obtain the holding electrode 9. Then, spin-on glass as an insulating film is formed with a thickness of approximately 1.2 microns on the holding electrode 9. Then, an ITO is formed with a thickness of 120 nanometers on the insulating film by sputtering and then patterned in the size of a pixel so as to obtain the second electrode 8. Then, an acrylic resin whitened by being mixed with titanium dioxide particles is applied with a thickness of approximately 1 micron onto the second electrode 8. Then, openings of 10 microns per side are made in the acrylic resin at intervals of 25 microns by photolithography and dry etching using argon. A silicone oil is used as the electrophoretic dispersion liquid. Carbon black particles with a diameter of 0.2 micron coated with a resin as the charged particles 6 are dispersed with a concentration of 4 wt % in the electrophoretic dispersion liquid.

In order to stabilize the dispersion, a metal soap of 3 wt % as an electric conductive agent is added to the liquid. The resultant liquid is injected between the two substrates and sealed with a sealing material. Here, when the carbon black charged particles 6 were charged positively and a voltage was applied from the control unit 13 for electrophoresis so that the potential of the second electrode 8 becomes higher than that of the first electrode 7 by five volts, the particles 6 were collected into the openings 11 of the insulating film 10 and a while image was identified in a view from the first electrode substrate. When the control unit 13 for electrophoresis was switched off and the control unit 14 for holding image was switched on according to the above-described operation method so that the potential of the holding electrode 9 becomes higher than that of the first electrode 7 by ten volts, the image was maintained as it is. Subsequently, even when the control unit 14 for holding image was switched off, the image was continuously maintained.

While a PET is used as the material of the electrode substrates in this embodiment, a transparent inorganic substance such as glass or quartz crystal as well as a transparent plastic such as polycarbonate may be used. Also, if the insulating film 10 serves as a reflection film, the second electrode substrate need not be transparent. Therefore, a metal substrate, a surface of which is coated with an insulating layer, as well as these materials may be used as the second electrode substrate. A photosensitive polyimide, a photosensitive acrylic resin, or the like may be used as a photosensitive resin for forming the partition wall 4. With regard to the insulating film 10, as the thickness thereof is reduced, a voltage to be applied to the holding electrode 9 in order to hold an image is reduced. Therefore, a polyimide or an acrylic resin having high dielectric strength as well as the spin-on glass used in this embodiment is suitably used as the material of the insulating film 10.

An ITO identical to the ITO used as the first electrode is used as the materials of the second electrode and holding electrode in this embodiment; however, a metal may be used as these electrodes. This is because these electrodes need not be transparent if the insulting film 10 serves as a reflection film. However, it is not preferable to use, as the second electrode, copper, iron, aluminum, silver, or the like that causes an electrode reaction and is thus apt to deteriorate. This is because the second electrode is directly in contact with the electrophoretic dispersion liquid. Also, photolithography is used in this embodiment in order to pattern the second electrode and holding electrode in the size of a pixel; however, the patterning may be performed using a metal mask when forming an electrode film by sputtering or vacuum deposition. Also, a pattern electrode may be directly formed using an electrode material that can be applied. Among transparent materials that may be used as the electrophoretic dispersion liquid 6 are xylene, toluene, silicone oil, liquid paraffin, organic chloride, various types of carbon hydrides, and various types of aromatic hydrocarbons. These materials may be used singly or in combination. Materials having low viscosities are preferably used in terms of the migration speed.

Various types of organic pigments or inorganic pigments may be used as the charged particles 6. Various materials are available by color. Among materials available as black are carbon black, graphite, black iron oxide, ivory black, and chromium dioxide. These materials may be used singly or in combination. Among materials available as white are titanium dioxide, magnesia oxide, and barium titanate. While the insulating film serving also as a reflection film is whitened by mixing an acrylic resin with a titanium oxide in this embodiment, a pigment having a different color may be mixed. Also, combinations of the color of the insulating film and that of the charged particles allow display of images having various colors. Also, by coating each pixel with a reflection film having a different color and causing the pixels to operate separately, an imaging apparatus capable of color display is obtained.

### Second Embodiment

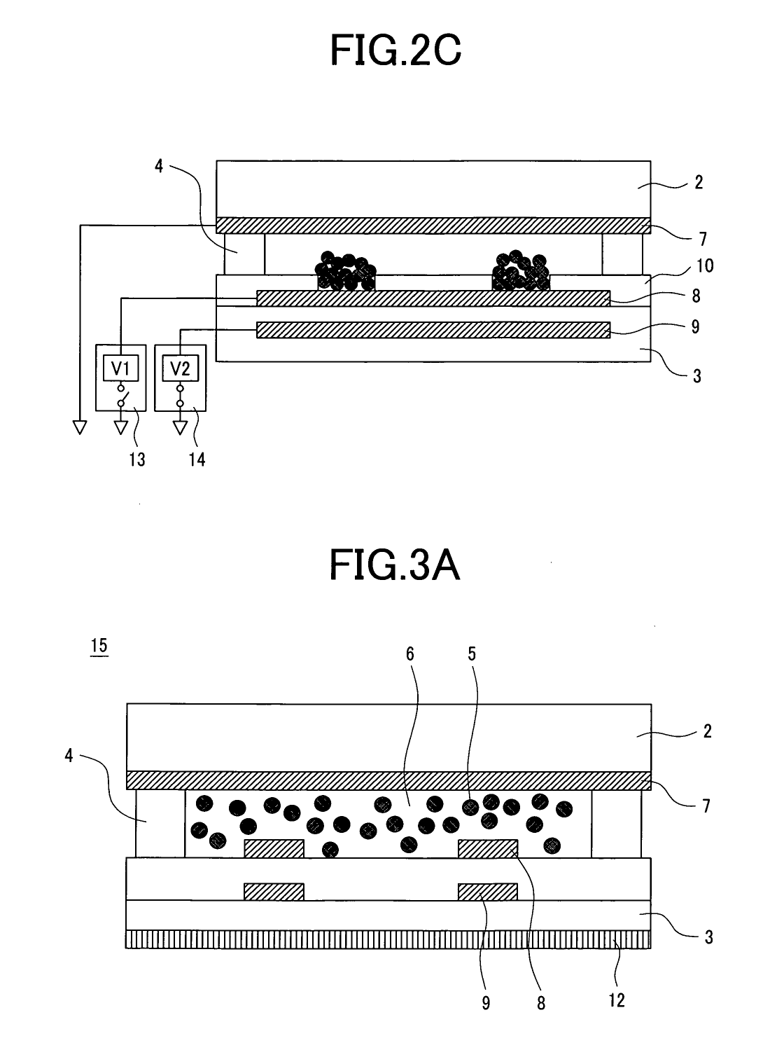

Pixels of an electrophoretic imaging device according to a second embodiment of the present invention will be described with reference to FIGS. 3A and 3B.

As with the pixels 1, pixels 15 each includes the first substrate 2 and second electrode substrate 3, the partition wall 4 disposed between the substrates 2 and 3 and intended to maintain the gap therebetween at a fixed size, and the transparent electrophoretic dispersion liquid 6 with which the space enclosed by the substrates 2 and 3 and the partition wall 4 is filled and in which black charged particles 5 are dispersed. FIGS. 3A and 3B are different from FIGS. 2A to 2C in the shapes of the second electrode and holding electrode and in that there is no insulating film with openings on the second electrode. Note that the control units coupled to the electrodes are not shown in FIG. 3A. The second electrode 8 and holding electrode 9 are patterned in identical shapes. The areas of these electrodes are both smaller than one-fourth the area of one of the pixels 15. These electrodes are each patterned in the form of a lattice in this embodiment; however, if these electrodes each have a shape expanding uniformly across a pixel, such as a comb, the distance over which the particles migrate is reduced and the response speed is advantageously improved. While the second electrode 8 and holding electrode 9 have identical shapes in this embodiment, their shapes may be different. However, in this case, when keeping the particles 5 collected on the second electrode 8, the particles may move and diffuse so that contrast is impaired.

Since the second electrode 8 and holding electrode 9 need not be transparent in this embodiment, a shape identical to that of the holding electrode 9 is easily transferred to the position of the second electrode 8 by forming the holding electrode 9 using a non-transparent material and performing back side exposure photolithography using the holding electrode 9 as a mask.

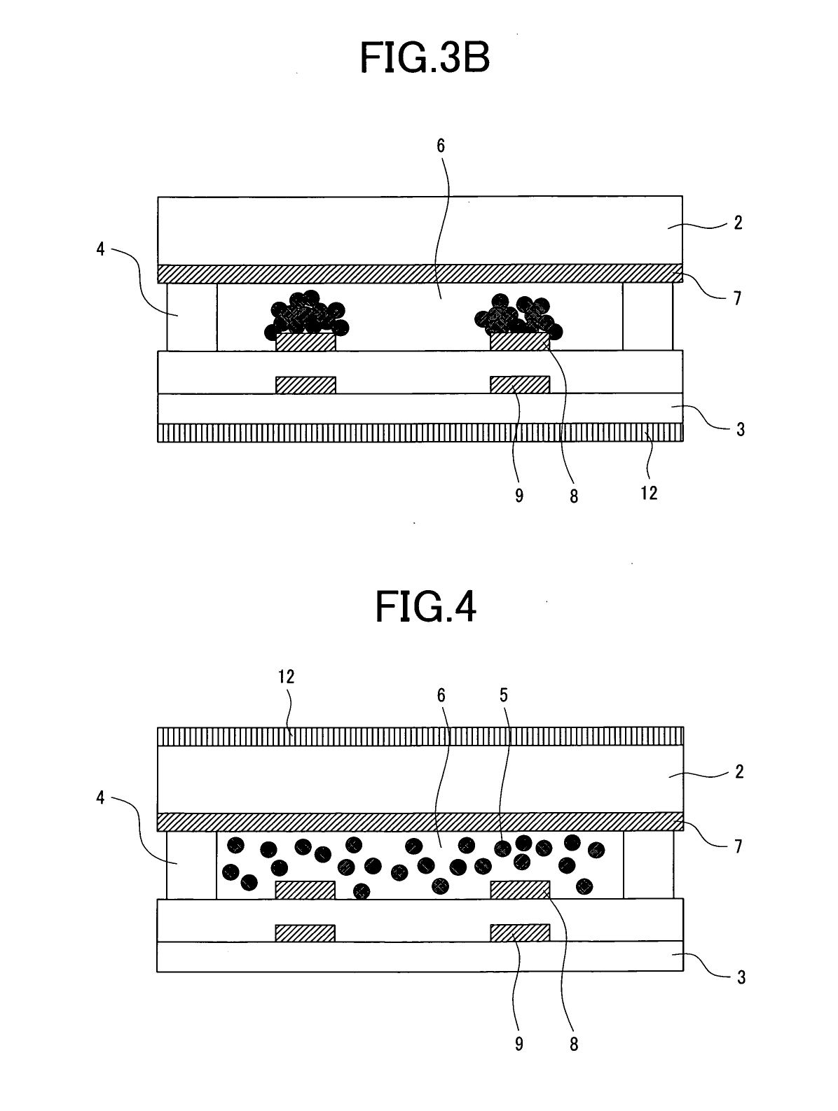

Also, in a structure identical to FIGS. 3A to 3C, the reflection film 12 may be disposed on the first electrode substrate 2 as shown in FIG. 4 so that an image is observed from the side of the second electrode substrate 3. In this case, the second electrode substrate 3 must be transparent. Also, the first electrode 7 may serve also as the reflection film 12. In this case, the first electrode substrate need not be transparent.

### Third Embodiment

Now, a configuration of an electrophoretic imaging device according to a third embodiment of the present invention in which the pixels 1 described in FIGS. 1A and 1B are arranged in a matrix will be described.

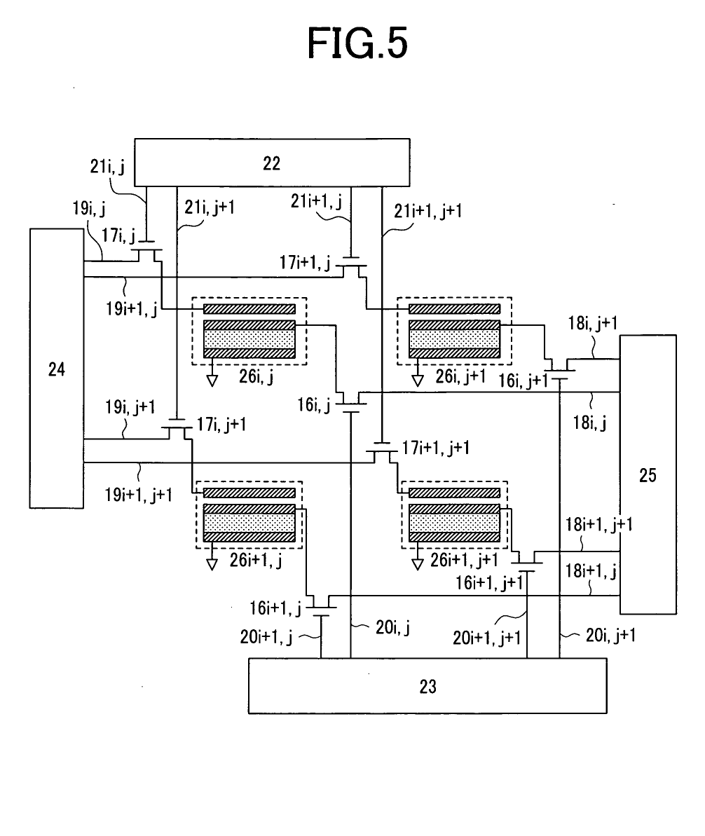

FIG. 5 is a diagram showing a drive circuit of the imaging device according to this embodiment. While the drive circuit will be hereafter described using a 2×2 matrix, a larger matrix may be used, as a matter of course. First, a thin film transistor 16 for electrophoresis (16i, j, 16i+1, j, 16i, j30 1, . . . ) and a thin film transistor 17 for holding image (17i, j, 17i+1, j, 17i, j+1, . . . ) are combined on a matrix. Then, a drain wire 18 for electrophoresis (18i, j, 18i+1, j, 18i, j+1, . . . ), a drain wire 19 for holding image (19i, j, 19i+1, j, 19i, j+1, . . . ), a gate wire 20 for electrophoresis (20i, j, 20i+1, j, 20i, j+1, . . . ), and a drain wire 21 for holding image (21i, j, 21i+1, j, 21i, j+1, . . . ) are driven by drive circuits 22, 23, 24, and 25. Thus, the migration of particles in a pixel cell 26 (26i, j, 26i+1, j, 26i, j+1, . . . ) is controlled so that an image is displayed. The drain wire 18 for electrophoresis (18i, j, 18i+1, j, 18i, j+1, . . . ) is coupled to the second electrode of each pixel cell and the drain wire 19 for holding image (19i, j, 19i+1, j, 19i, j+1, . . . ) is coupled to the holding electrode of each pixel cell. On the other hand, the first electrode of each pixel cell is common to all the pixels and coupled to a ground.

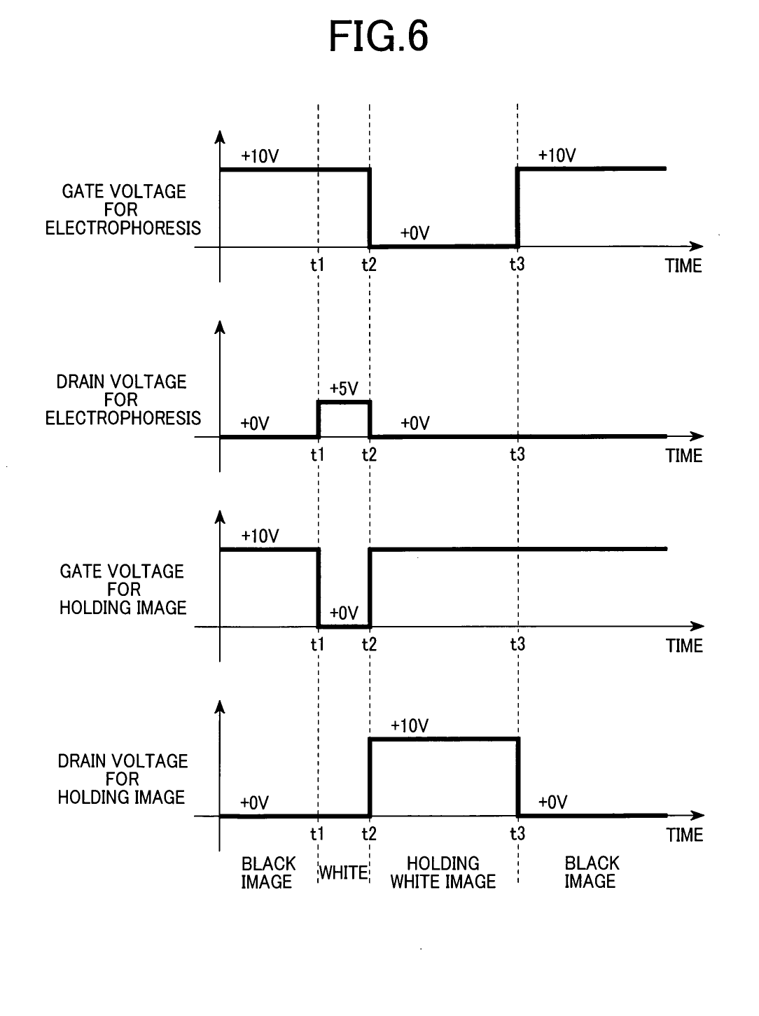

FIG. 6 is a timing chart diagram showing image rewriting/holding operations performed by the electrophoretic imaging device shown in FIG. 5. FIG. 6 shows voltages applied to a drain wire 18i, j for electrophoresis, a drain wire 19i, j for holding image, a drain wire 20i, j for electrophoresis and a drain wire 21i, j for holding image if a pixel cell 26i, j displays a black image from time 0 to t1, displays a white image from t1 to t2, holds the white image from t2 to t3, and displays a black image again at t3 and later.

While monochrome images, that is, a while image and a black image have been described in this specification, color filters for transmitting red, green, and blue may be disposed on these pixels so as to display color images. Also, the colors of the reflection films are solely white in this specification; however, the reflection films may be colored with red, green, and blue so as to display color images.

What is claimed is:

1. A method for operating an electrophoretic imaging device including: first and second substrates disposed so as to be opposed to each other with a gap therebetween; a first electrode disposed on a main surface of the first substrate; a second electrode disposed on a main surface of the second substrate so as to be opposed to the first electrode; a partition wall disposed in the gap, the partition wall partitioning the gap into a plurality of partitions; an electrophoretic dispersion liquid with which a space enclosed by the first electrode, the second substrate, and the partition wall is filled, the electrophoretic dispersion liquid including ions; a migratable, charged particle mixed into the electrophoretic dispersion liquid; and a holding electrode disposed away from the second electrode on a side of the second electrode remote from the first electrode, the holding electrode being electrically insulated from the second electrode and the electrophoretic dispersion liquid, the method comprising the steps of:
applying a predetermined voltage between the first and second electrodes; and
after a given time has elapsed, opening a circuit between the first and second electrodes to apply a voltage larger than the predetermined voltage between the first electrode and the holding electrode.

2. The method for operating an electrophoretic imaging device according to claim 1, wherein the first electrode is coupled to a ground potential.

3. The method for operating an electrophoretic imaging device according to claim 1,
wherein the second electrode is covered by an insulating film having an opening in a predetermined position, and
a total area of the opening is smaller than a surface area of the second electrode enclosed by the partition wall.

4. The method for operating an electrophoretic imaging device according to claim 1,
wherein the second electrode is patterned in a predetermined form, and
a total area of a surface of the patterned second electrode in contact with the electrophoretic dispersion liquid is smaller than an area of a surface of the second substrate enclosed by the partition wall.

5. The method for operating an electrophoretic imaging device according to claim 4, wherein the holding electrode has a shape identical to a shape of the second electrode at least in a partition enclosed by the partition wall, and is disposed in a position in which the second electrode is overlaid on the holding electrode at least in a partition enclosed by the partition wall if the holding electrode is seen from a side of the first electrode.

6. An electrophoretic imaging device comprising:
first and second substrates disposed so as to be opposed to each other with a gap therebetween;
a first electrode disposed on a main surface of the first substrate;
a second electrode disposed on a main surface of the second substrate so as to be opposed to the first electrode;
a partition wall disposed in the gap, the partition wall partitioning the gap into a plurality of partitions;
an electrophoretic dispersion liquid with which a space enclosed by the first electrode, the second substrate, and the partition wall is filled, the electrophoretic dispersion liquid including ions;
a migratable, charged particle mixed into the electrophoretic dispersion liquid; and
a holding electrode disposed away from the second electrode on a side of the second electrode remote from the first electrode, the holding electrode being electrically insulated from the second electrode and the electrophoretic dispersion liquid.

7. The electrophoretic imaging device according to claim 6, wherein a surface area of the second electrode in contact with the electrophoretic dispersion liquid is smaller than a surface area of the second electrode enclosed by the partition wall.

8. The electrophoretic imaging device according to claim 6, further comprising an insulating film provided so as to cover the second electrode, the insulating film having an opening in a predetermined position,
wherein a total area of the opening is smaller than a surface area of the second electrode enclosed by the partition wall.

9. The electrophoretic imaging device according to claim 8,
wherein the first electrode, the first substrate, and the electrophoretic dispersion liquid are all transparent, and
the insulating film is colored with a color different from a color of the charged particle.

10. The electrophoretic imaging device according to claim 8, further comprising a reflection film provided on a surface of the second substrate remote from the first electrode or provided in the second substrate, the reflection film having a color different from a color of the charged particle,
wherein the insulating film, the second electrode, the holding electrode, and the second substrate are all transparent.

11. The electrophoretic imaging device according to claim 6,
wherein the second electrode is patterned in a predetermined form, and
a total area of a surface of the patterned second electrode in contact with the electrophoretic dispersion liquid is smaller than an area of a surface of the second substrate enclosed by the partition wall.

12. The electrophoretic imaging device according to claim 11, further comprising a reflection film provided on a surface of the second substrate opposed to a surface thereof in contact with the electrophoretic dispersion liquid or provided in the second substrate, the reflection film having a color different from a color of the charged particle,
wherein the first electrode, the first substrate, the electrophoretic dispersion liquid, and the second substrate are all transparent.

13. The electrophoretic imaging device according to claim 12, wherein the holding electrode has a shape identical to a shape of the second electrode at least in a partition enclosed by the partition wall, and is disposed in a position in which the second electrode is overlaid on the holding electrode at least in a partition enclosed by the partition wall if the holding electrode is seen from a side of the first electrode.

14. The electrophoretic imaging device according to claim 11, further comprising a reflection film provided on a surface of the first substrate opposed to a surface thereof in contact with the electrophoretic dispersion liquid or provided in the first substrate, the reflection film having a color different from a color of the charged particle,
wherein the first electrode, the first substrate, the electrophoretic dispersion liquid, and the second substrate are all transparent.

15. The electrophoretic imaging device according to claim 14, wherein the holding electrode has a shape identical to a shape of the second electrode at least in a partition enclosed by the partition wall, and is disposed in a position in which the second electrode is overlaid on the holding electrode at least in a partition enclosed by the partition wall if the holding electrode is seen from a side of the first electrode.
